(19) United States
(12) Patent Application Publication
(10) Pub. No.: US 2006/0117897 A1
(43) Pub. Date: Jun. 8, 2006

(54) Joint unit for a robot

(75) Inventor: Markus Grebenstein, Munich (DE)

Correspondence Address: WILLIAM COLLARD;COLLARD & ROE, P.C., 1077 NORTHERN BOULEVARD, ROSLYN, NY, 11576, US

(73) Assignee: Deutsches Zentrum fur Luft-und Raumfahrt e. V.

(21) Appl. No.: 11/296,128

(22) Filed: Dec. 7, 2005

(30) Foreign Application Priority Data
Dec. 8, 2004 (DE) 10 2004 059 235.7

(51) Int. Cl. B25J 17/00

(52) U.S. Cl. 74/490.05

(57) ABSTRACT

A driven joint unit for a robot has two drive rollers mounted in a frame, driven by a motor in each instance. There is also a differential cone wheel stage, in each instance which consists of two deflection cone wheels, forming a first pair of cone wheels, mounted coaxially in the frame, preferably parallel to the axes of the coaxial drive rollers, whose axes, which extend in the direction of a first robot axis, form a first joint axis. There are also two coaxially disposed power take-off wheels, forming a second pair of cone wheels, the axes of which extend in a second joint axis perpendicular to the first joint axis. One of the two power take-off wheels is rigidly connected with the power take-off, and the other opposite coaxial power take-off cone wheel is mounted to be rotationally freely movable. There is also a number of biased tension means of which at least respectively two tension means are attached to the two drive rollers and are directed in opposite directions. These tension means are guided around a part of the adjacent deflection cone wheels in each instance. Said at least respectively two tension means are attached to said rotationally freely movable power take-off cone wheel and to said power take-off wheel that is rigidly connected with the power take-off, respectively.

### CROSS REFERENCE TO RELATED APPLICATIONS

Applicant claims priority under 35 U.S.C. §119 of German Application No. 10-2004059235.7 filed on Dec. 8, 2004 wherein the disclosure of which is hereby incorporated herein by reference.

### BACKGROUND OF THE INVENTION

The invention relates to a driven joint unit for a robot.

Conventional robot joints have a clear connection, or assignment between the drives and the power take-offs. This clear assignment between drive and power take-off in the case of robot joints results in restricted usability of the existing drive resources, particularly in the case of coupled joints, since every drive can always be utilized only for one joint, in each instance.

### SUMMARY OF THE INVENTION

At least one embodiment of the invention was designed to provide optimal utilization of several drives for a multi-axle power take-off movement. Thus, this embodiment includes a drive joint unit for a robot.

With a driven joint unit for a robot as described for the above embodiment, there are two drive rollers mounted in a frame, driven by a motor, in each instance. These drive rollers are followed by a differential cone wheel stage, which comprises two deflection cone wheels mounted coaxially in the frame, preferably parallel to the axes of the drive rollers, and is comprised of two coaxially disposed power take-off wheels. In this case, one of the two power take-off wheels is rigidly connected with the power take-off, while the other opposite coaxial power take-off cone wheel is mounted to be rotationally freely movable.

Furthermore, with this joint unit, there is a number of biased tension means which includes at least respectively two tension means attached to the two drive rollers and which are directed in opposite directions. These means are guided around a part of the adjacent deflection cone wheel, in each instance, preferably crossing one another, and are attached to the adjacent rotationally freely movable power take-off cone wheel, and to the power take-off wheel that is rigidly connected with the power take-off, respectively.

Thus, there is created a driven cardanic joint that is free of play, in which the drive moment is directly transferred to the power take-off.

With this design, the load moment is distributed along the main movement directions, precisely uniformly, to the drive motors. In this case, particularly in the case of redundant robot-kinematics, it is possible to have power-optimized operation of the joint unit and therefore of the robot. The optimal movement directions of the joint are used as optimization criteria for designating the inverse kinematics of redundant kinematics.

With this design, the inverse kinematics of a robot having redundant degrees of freedom are solved using an additional condition that guarantees the most uniform possible capacity utilization of the drives and therefore power-optimal and weight-optimal dimensioning of the drives.

There can also be a power-optimized and weight-optimized robot joint, using a differential cone wheel gear mechanism, wherein for any movement in the two main directions the moment is uniformly applied by the two drives.

This design can result in a play-free, power-optimized differential joint unit for a robot between the two drive motors and the power take-off cone wheels. This design can also provide a biased force transfer.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawing, wherein similar reference characters denote similar elements throughout the several views:

FIG. 1 is a schematic perspective overall view of a driven joint unit;

FIG. 2 is a schematic perspective partial view of the joint unit of FIG. 1, in which part of the frame is not shown;

FIG. 3 is another schematic perspective partial view of the joint unit of FIG. 1 from another viewing angle, and

FIG. 4 is another perspective partial view of the joint unit, wherein with part of the frame, one of the deflection cone wheels, one of the power take-off cone wheels, as well as a stirrup connecting the power take-off wheels are not shown.

### DETAILED DESCRIPTION OF PREFERRED EMBODIMENTS

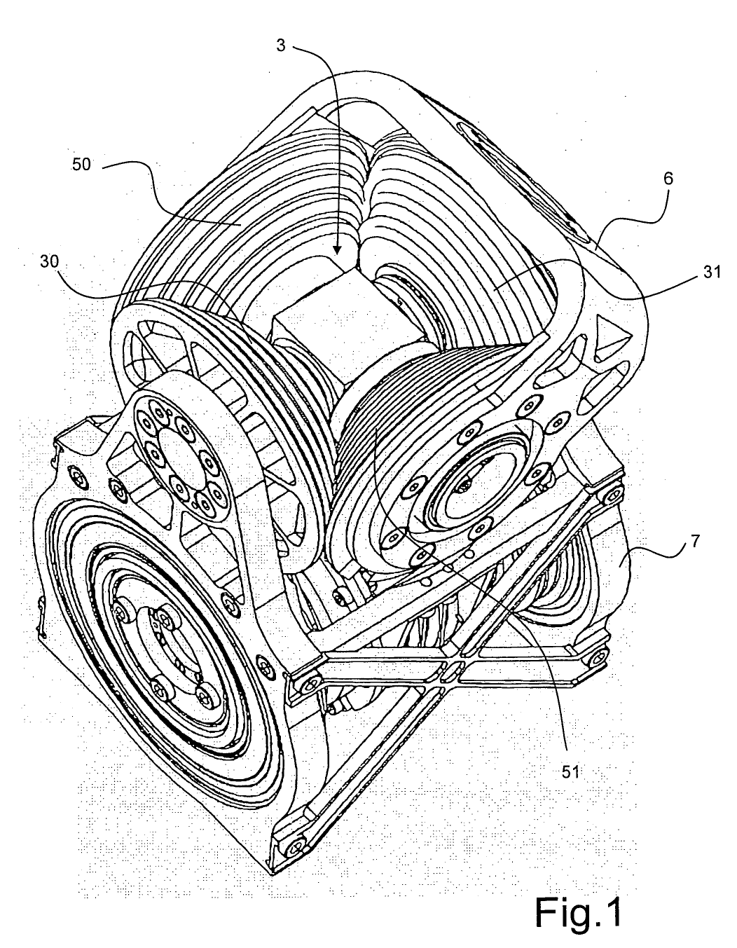

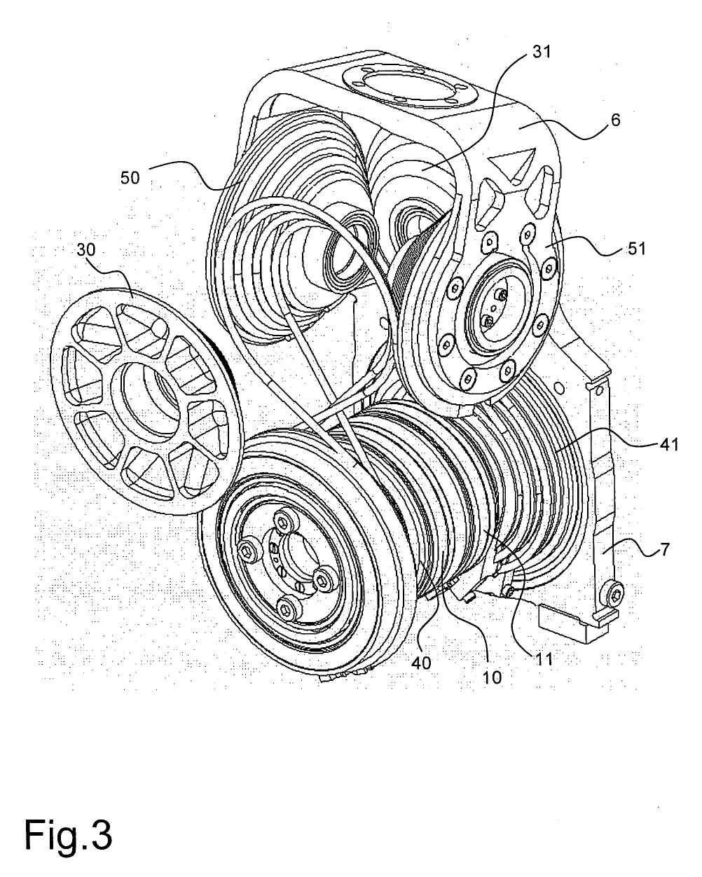

Turning now in detail to the drawings, FIG. 1 shows a driven joint unit for a robot which will be described below, using FIGS. 1 to 4. Two drive motors 10 and 11 are disposed in the lower region of frame 7, which is shown only in part. The drive torque of drive rollers 40 and 41 driven by motors 10 and 11 is transferred to power take-off cone wheels 50 and 51 by way of deflection cone wheels 30 and 31.

Power take-off cone wheels 50 and 51 are connected with one another by means or a device provided on the power take-off side. This means or device can be in the form of a stirrup 6, whereby power take-off cone wheel 51, for example, is rigidly connected with one shank of stirrup 6, while the other opposite power take-off cone wheel 50 is mounted to the other shank of this stirrup 6, so as to be rotationally freely movable. Two deflection cone wheels 30 and 31 mounted coaxially in frame 7 are disposed preferably parallel to the axes of the drive rollers 40 and 41 and thereby form a first pair of cone wheels.

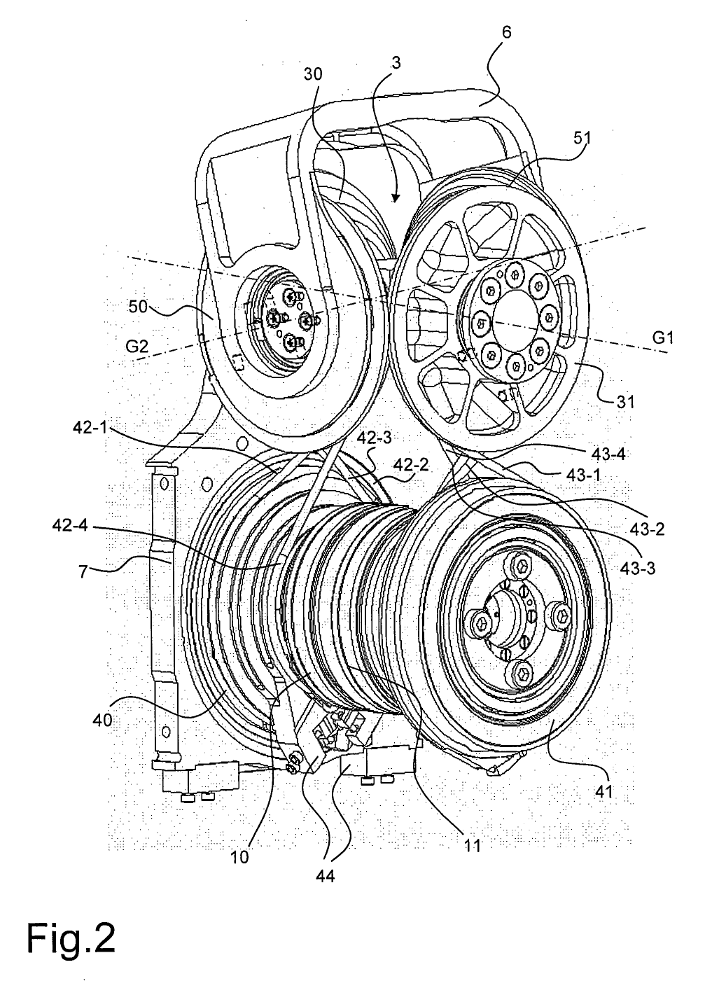

The axes of two deflection cone wheels 30 and 31 extend in the direction of a first robot axis, not specifically represented in the drawings, and thereby form a first joint axis G1 (see FIG. 2). The two power take-off cone wheels 50 and 51, which are also disposed coaxially, form a second pair of cone wheels. The axis of these cone wheels in turn extends in the direction of a second joint axis G2, which is perpendicular to first joint axis G1.

Thus, the two drive motors 10 and 11 are equally necessary both for movements about the first joint axis G1 and also for movements about the second joint axis G2. By means of this measure according to the invention, the required motor torque for movements in the direction of the two joint axes is cut in half. Thus, the required power of the drive motors and therefore, also their size and mass can be reduced very significantly. In advantageous manner, this design of the joint unit is therefore configured as a very compact cardanic joint.

However, to implement a play-free or tightly coupled joint drive, there are biased tension means, such as cables, belts, or other biased gear mechanisms. While no biased tension means are shown in the perspective schematic representation of FIG. 1, part of the tension means 42-1 to 42-4 as well as 43-1 to 43-4 is shown in FIGS. 2 to 4.

With this design, four cables would be sufficient for the function of the joint unit shown in FIGS. 1 to 4, specifically per drive side one cable for the one movement direction, and another cable for the second movement direction. Only in this manner is it possible to provide the drive power of motors 10 and 11 for both activation directions.

As explained above, however, with the joint unit shown in FIGS. 2 to 4, all of the cables are present as doubles. This means that the innermost and outermost pull cable 42-1 and 43-1, respectively, and 42-4 and 43-4, respectively, as well as the center cables 42-2 and 42-3, respectively, and 43-2 and 43-3, respectively, fulfill the same purpose, in each instance.

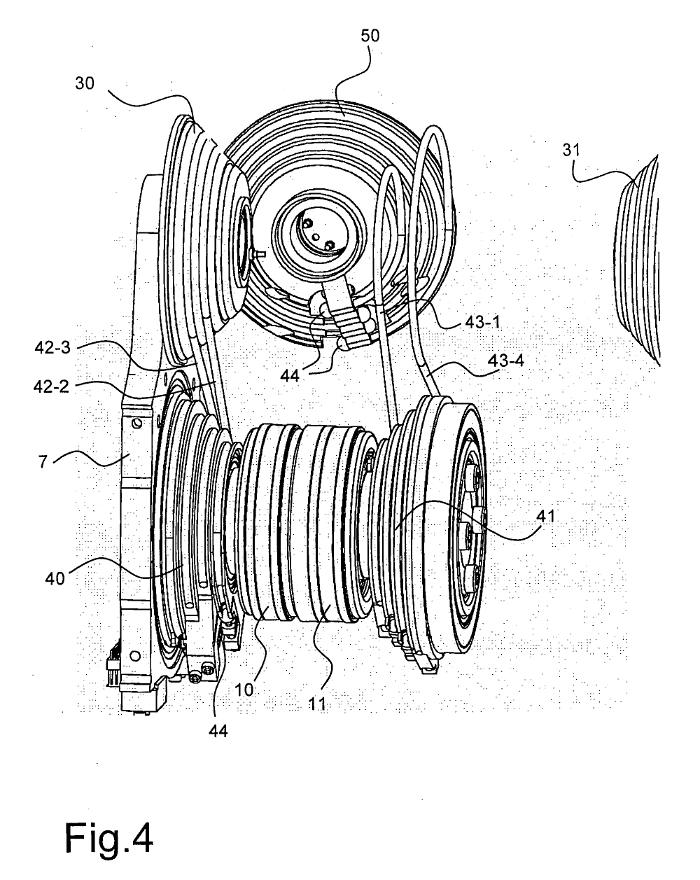

Since the cables have to be biased against one another, and only pull can be transferred with cables, at least two cables disposed directly in opposite directions, have to be attached to each drive roller 40 or 41. Specifically, for example, these doubles exist as one of the two center pull cables 42-2 and 43-2 and one of the outer pull cables, for example 42-4 and 43-4. In FIGS. 2 to 4, however, not all of the biased tension means are shown, although all of the cables are provided double, for safety reasons, as, for example, the tension means 42-1 to 42-4 and 43-1 to 43-4 in FIG. 2, or the tension means 42-2 and 42-3 as well as 43-1 and 43-4 in FIG. 4.

For this purpose, the pull cables are fixed in place on the drive rollers 40 and 41, in each instance, by means of attachment elements, for example by means of the attachment elements 44 indicated in FIGS. 2 and 4. With this design, pull cables 43-1 to 43-4 attached to drive roller 41, for example, cross over to deflection roller 31, as is clearly evident in the transition region (FIG. 2) between drive roller 41 and deflection cone wheel 31. In addition, outer pull cables 43-1 and 43-4 run from drive roller 41 at a slant to the left top, to deflection cone wheel 31, while pull cables 43-2 and 43-3 pass between pull cables 43-1, 43-4, and run at a slant to the right top, to deflection cone wheel 31.

The other ends of the cables are attached to the corresponding power take-off wheels, as shown for example, in FIG. 4, where cables 43-1 and 43-4 are attached to the power take-off cone wheel 50 via attachment elements 44.

Inverse kinematics of the system cannot be clearly solved for the operation of robots having redundant degrees of freedom, since an under-determined equation system is formed. Accordingly, there must/can be additional optimization criteria.

The driven joint unit described using FIG. 1 to 4 distributes the drive moment in equal parts to two drives 10, 11, in the main movement directions of the joint unit, about joint axes G1 and G2, and thereby makes motors with significantly smaller dimensions possible. With this design, it proves to be practical to define an optimization criterion that ensures that all of the movements of the robot occur as precisely as possible in the main movement directions, and therefore put equal stress on the two drives 10, 11. In this way, it is possible to achieve the best possible capacity utilization of the two drives. A play-free drive is implemented with the joint unit shown in FIG. 1 to 4, using the biased tension means.

The driven joint unit can be used as a joint in any robot arm having rotational joints. Beyond use in combination with robots, the joint unit can be used for all other two-axis tasks as well as in combination for all other multi-axis positioning tasks with rotational drives. To better utilize the drive power, the joint unit can also be used for robots used in surgery, particularly in minimally invasive surgery.

Accordingly, while a few embodiments of the present invention have been shown and described, it is to be understood that many changes and modifications may be made thereunto without departing from the spirit and scope of the invention as defined in the appended claims.

What is claimed is:

1. A joint unit for a robot comprising:
a) a frame;
b) two drive rollers mounted on said frame, wherein each of said two drive rollers is driven by a motor;
c) a differential cone wheel stage comprising:
i) two deflection cone wheels forming a first pair of cone wheels, mounted coaxially in said frame, preferably parallel to axes of said two drive rollers wherein axes of said two deflection cone wheels which extend in a direction of a first robot axis, form a first joint axis;
ii) two coaxially disposed power take-off wheels, forming a second pair of cone wheels, wherein axes of said two power take-off wheels extend in a direction of a second joint axis, perpendicular to said first joint axis, wherein one of said two power take-off wheels is rigidly coupled to said power take-off, and wherein the other opposite coaxial power take-off cone wheel is mounted to be rotationally freely movable;
iii) a number of biased tension means comprising at least respectively two tension means which are attached to said two drive rollers, which are directed in opposite directions, and are guided around a part of adjacent deflection cone wheels, and said at least respectively two tension means are attached on said power take-off cone wheel being rotationally freely movable and on said rigidly coupled power take-off cone wheel respectively.

2. The joint unit as in claim 1, wherein the joint unit is adapted to be a play-free, driven cardanic joint.
